(19) United States
(12) Patent Application Publication
(10) Pub. No.: US 2007/0286312 A1
(43) Pub. Date: Dec. 13, 2007

(54) Apparatus, method and computer program product providing iterative recursive least squares (RLS) algorithm for coded MIMO systems

(75) Inventor: Kyeong Jin Kim, Irving, TX (US)

Correspondence Address: HARRINGTON & SMITH, PC, 4 RESEARCH DRIVE, SHELTON, CT, 06484-6212, US

(73) Assignee: Nokia Corporation

(21) Appl. No.: 11/809,705

(22) Filed: May 31, 2007

Related U.S. Application Data
(60) Provisional application No. 60/810,570, filed on Jun. 1, 2006.

(51) Int. Cl. H04L 27/06

(52) U.S. Cl. 375/340

(57) ABSTRACT

A method embodiment receives a symbol vector on a plurality of channels. For each of the channels, the channel and a normalized frequency offset of the channel is estimated. Also for each of the channels, a soft decision value of the symbol vector is determined. An iterative recursive least squares RLS algorithm is executed on each of the channels that approximates a covariance matrix of a composite noise vector of the received symbol vector until a minimum change to the estimate of the channel and the estimate of the normalized frequency offset is reached. Using the recursively estimated channel and normalized frequency offset across each of the channels, a jointly decoded decision on the symbol vector is output. Embodiments for devices and computer programs are also detailed.

### CROSS-REFERENCE TO RELATED U.S. PROVISIONAL PATENT APPLICATION

This application claims priority to Provisional U.S. Patent Application No. 60/810,570 filed on Jun. 1, 2006, the contents of which is hereby incorporated by reference in its entirety including Exhibits A-M attached thereto.

### TECHNICAL FIELD

The exemplary and non-limiting embodiments of this invention relate generally to wireless communications systems, methods and computer program products and, more specifically, relate to multiple input-multiple output (MIMO) and orthogonal frequency division multiplex (OFDM) wireless communications systems, methods and computer program products.

### BACKGROUND

In recent years very powerful channel codes such as Low-Density Parity-Check (LDPC) codes (R. G. Gallager, “LOW-DENSITY PARITY-CHECK CODES”, IRE Trans. on Inform. Theory, pp. 21-28, January 1962, Exhibit A of the priority US provisional patent application) and Turbo codes (PHYSICAL LAYER STANDARD FOR CDMA2000 SPREAD SPECTRUM SYSTEMS (3GPP2 C.S0002-C), May 2002, Exhibit B of the priority US provisional patent application) have been proposed in different applications. To obtain the maximum advantages of these channel codes it is desirable to combine the channel decoders in the receiver. Several approaches to this have been described (e.g., see L. K. Rasmussen, A. J. Grant, and P. D. Alexander, “AN EXTRINSIC KALMAN FILTER FOR ITERATIVE MULTIUSER DECODING”, IEEE Trans. on Inform. Theory, vol. 50, pp. 642-648, April 2004 [Exhibit C of the priority US provisional patent application], K. J. Kim, T. Reid, and R. A. Iltis, “DATA DETECTION AND SOFT-KALMAN FILTER BASED SEMI-BLIND CHANNEL ESTIMATION ALGORITHMS FOR MIMO-OFDM SYSTEMS”, in Proceedings of ICC2005, 2005, pp. 2488-2492 [Exhibit D of the priority US provisional patent application], K. J. Kim and R. A. Iltis, “ITERATIVE KALMAN FILTER-BASED DATA DETECTION AND CHANNEL ESTIMATION FOR TURBO CODED MIMO-OFDM SYSTEMS”, submitted to the International Journal of Wireless Information Networks, 2005, and K. J. Kim, T. Bhatt, V. Stolpman, and R. A. Iltis, “PERFORMANCE ANALYSIS OF THE DETECTOR FOR THE STRUCTURED IRREGULAR LDPC CODED MIMO-OFDM SYSTEM”, to appear in the proceedings of ICASSP2006 [Exhibit F of the priority US provisional patent application]) where the a posteriori probability (APP) for the information bit computed by the channel decoder is used in the soft-data detector (see K. J. Kim, T. Reid, and R. A. Iltis, “SOFT DATA DETECTION ALGORITHM FOR AN ITERATIVE TURBO CODED MIMO OFDM SYSTEMS”, in Proceedings of the Asilomar Conference on Signals Systems and Computers, Pacific Grove, Calif., November 2004, pp. 1193-1197, Exhibit G of the priority US provisional patent application) in a form of the extrinsic information. In certain ones of the previously cited publications the soft decision for the coded symbol, where the expectation is applied with respect to the APP from the data detector, drives the channel estimators. Conditioned on the coded symbol decisions, various forms of channel estimators have been proposed.

Prior to this invention, no truly suitable procedure existed for jointly estimating channel and frequency offsets for quasi-static channel parameters such as-those present in a coded MIMO-OFDM system.

### SUMMARY

In accordance with one embodiment of the invention is a method that includes receiving a symbol vector on a plurality of channels. For each of the channels, the channel and a normalized frequency offset of the channel is estimated. Also for each of the channels, a soft decision value of the symbol vector is determined. An iterative recursive least squares RLS algorithm is executed on each of the channels that approximates a covariance matrix of a composite noise vector of the received symbol vector until a minimum change to the estimate of the channel and the estimate of the normalized frequency offset is reached. Using the recursively estimated channel and normalized frequency offset across each of the channels, a jointly decoded decision on the symbol vector is output.

In accordance with another embodiment of the invention is a program of machine-readable instructions, tangibly embodied on a computer readable memory and executable by a digital data processor, to perform actions directed toward outputting a decision on a received symbol vector. In this embodiment, the actions include receiving a symbol vector on a plurality of channels, and for each of the channels estimating the channel and a normalized frequency offset of the channel. Further for each of the channels is determined a soft decision value of the symbol vector. An iterative recursive least squares RLS algorithm is executed on each of the channels that approximates a covariance matrix of a composite noise vector of the received symbol vector until a minimum change to the estimate of the channel and the estimate of the normalized frequency offset is reached. A jointly decoded decision on the symbol vector is output using the recursively estimated channel and normalized frequency offset across each of the channels.

In accordance with another embodiment of the invention is a device that includes at least one receive antenna coupled to a receiver and adapted to receive a symbol vector on a plurality of channels, and a processor coupled to a memory. The processor is adapted, for each of the channels, to: estimate the channel and a normalized frequency offset of the channel, determine a soft decision value of the symbol vector, and execute an iterative recursive least squares RLS algorithm on each of the channels that approximates a covariance matrix of a composite noise vector of the received symbol vector until a minimum change to the estimate of the channel and the estimate of the normalized frequency offset is reached. The processor is further adapted to apply the recursively estimated channel and the normalized frequency offset across each of the channels in order to determine a jointly decoded decision on the symbol vector.

In accordance with another embodiment of the invention is a device that includes means for receiving a symbol vector on a plurality of channels, means for estimating the channel and a normalized frequency offset of the channel for each of the channels, means for determining a soft decision value of the symbol vector for each of the channels, and means for executing an iterative recursive least squares RLS algorithm on each of the channels that approximates a covariance matrix of a composite noise vector of the received symbol vector until a minimum change to the estimate of the channel and the estimate of the normalized frequency offset is reached. Further, the device includes means for outputting a jointly decoded decision on the symbol vector using the recursively estimated channel and normalized frequency offset across each of the channels.

In a particular embodiment of the device immediately above, the means for receiving includes at least one receive antenna coupled to a receiver; the means for determining includes a detector of a processor for each channel; and the means for estimating and means for executing includes a processor coupled to a memory for storing a program. The means for outputting can be simply a terminal pin of the processor.

These and other aspects of the invention are detailed with particularity below.

### BRIEF DESCRIPTION OF THE DRAWINGS

Embodiments of the invention are particularly described with reference to the attached Drawing Figures.

FIG. 1 shows a simplified block diagram of various electronic devices that are suitable for use in practicing the exemplary embodiments of this invention.

FIGS. 2 and 3 are graphs showing bit error rate BER performance.

FIG. 4 is a graph showing estimator performance for frequency offset at 20 subdecoding iterations.

FIG. 5 is a graph showing estimator performance for channel at 20 subdecoding iterations.

FIG. 6 is a logic flow diagram that shows the execution of a method in accordance with the exemplary embodiments of this invention.

### DETAILED DESCRIPTION

Described herein is an extended soft-recursive least squares (ES-RLS) algorithm for a coded MIMO-OFDM system. The ES-RLS algorithm extends and improves a conventional extended RLS (E-RLS) algorithm described in S. Haykin, A. H. Sayed, J. R. Zeidler, P. Yee, and P. C. Wei, “ADAPTIVE TRACKING OF LINEAR TIME-VARIANT SYSTEMS BY EXTENDED RLS ALGORITHMS”, IEEE Trans. on Signal Processing, vol. 45, pp. 1118-1128, May 1997 (Exhibit H of the priority US provisional patent application). It is also shown that for single-carrier systems, such as one described in M. Tuchler, A. C. Singer, and R. Koetter, “MINIMUM MEAN SQUARED ERROR EQUALIZATION USING A PRIORI INFORMATION”, IEEE Trans. on Signal Processing, vol. 50, pp. 673-683, March 2002 (Exhibit I of the priority US provisional patent application), that an iterative minimum-mean square error (MMSE) equalizer combined with a soft data detector lead to both improved channel estimation and BER performance. Thus, iterative joint estimation/detection structures based on these latter methods may also yield better BER performance in coded OFDM systems with unknown channels. The exemplary embodiments of this invention provide an iterative ES-RLS (IES-RLS) MIMO-OFDM channel and frequency offset estimator, and combines it with the MIMO-OFDM soft-QRD-M data detector described in the above-referenced K. J. Kim, T. Reid, and R. A. Iltis, “SOFT DATA DETECTION ALGORITHMS FOR AN ITERATIVE TURBO CODED MIMO OFDM SYSTEMS”, in Proceedings of the Asilomar Conference on Signals Systems and Computers, Pacific Grove, Calif., November 2004, pp. 1193-1197, to provide a novel semi-blind joint channel and frequency offset estimation and data detection algorithm.

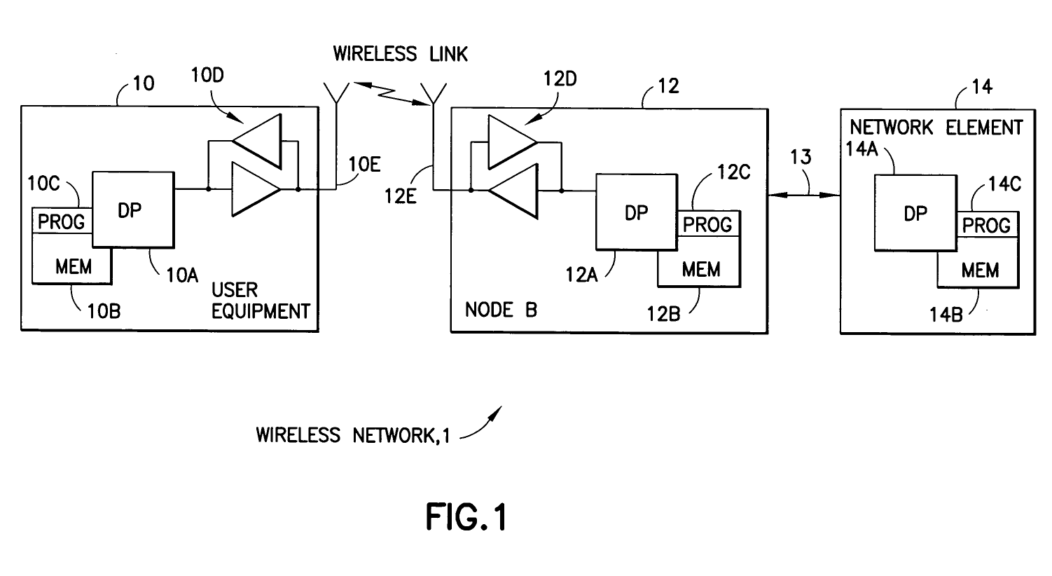

Reference is made first to FIG. 1 for illustrating a simplified block diagram of various electronic devices that are suitable for use in practicing the exemplary embodiments of this invention. In FIG. 1 a wireless network 1 is adapted for communication with a UE 10 via a Node B (base station) 12. The network 1 typically includes a network element 14, which may be referred to as a serving network element. The UE 10 includes a data processor (DP) 10A, a memory (MEM) 10B that stores a program (PROG) 10C, and a suitable radio frequency (RF) transceiver 10D coupled to one or more antennas 10E (one shown) for bidirectional wireless communications with the Node B 12, which also includes a DP 12A, a MEM 12B that stores a PROG 12C, and a suitable RF transceiver 12D coupled to one or more antennas 12E (one shown). The Node B 12 is coupled via a data path 13 (e.g., Iub link) to the network element 14 that typically also includes a DP 14A and a MEM 14B storing an associated PROG 14C. At least one of the PROGs 10C and 12C is assumed to include program instructions that, when executed by the associated DP, enable the electronic device to operate in accordance with the exemplary embodiments of this invention, as will be discussed below in greater detail. It is understood that while described in the context of a MIMO system, these teachings are readily implemented in particular variations of MIMO systems, such as single input single output (SISO), single input multiple output SIMO systems and multiple input single output MISO systems.

For the purposes of describing the exemplary embodiments of this invention the wireless network 1 may be assumed to implement a coded MIMO-OFDM system. Also, while a single antenna 10E, 12E is shown at the UE 10 and Node B 12 for simplicity, there may be a plurality of transmit and/or receive antennas present at each network element.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The exemplary embodiments of this invention may be implemented by computer software executable by the DP 10A of the UE 10 and the other DPs, or by hardware, or by a combination of software and hardware.

The MEMs 10B, 12B and 14B may be of any type suitable to the local technical environment and may be implemented using any suitable data storage technology, such as semiconductor-based memory devices, magnetic memory devices and systems, optical memory devices and systems, fixed memory and removable memory. The DPs 10A, 12A and 14A may be of any type suitable to the local technical environment, and may include one or more of general purpose computers, special purpose computers, microprocessors, digital signal processors (DSPs) and processors based on a multi-core processor architecture, as non-limiting examples.

Described first is a signal model for the coded-MIMO-OFDM system.

Considered herein is a baseband model for a received MIMO OFDM signal over a multipath fading channel. The notation used for the MIMO-OFDM system includes the following:
N₇₁ ,Nₜ,Nᵣ: number of multipaths and antennas in transmitter and receiver.
K,N: number of subcarriers and OFDM data symbols in one packet.

$${T}_{g} , {T}_{d} {=}^{△} {KT}_{s} , {T}_{s} \text{:}$$

guard time interval, OFDM data symbol interval, and sampling time.
A, a, (A)_{l,m}, (a)ₖ: a matrix, a vector, the (l,m) element of the matrix A, and the k-th element of the vector a.
Λ(α₁, . . . , α_{N}): a diagonal matrix with {α₁, . . . , α_{N}}.
F∈C^{K×K}: IFFT matrix whose (l,m) element is

$$\frac{1}{\sqrt{K}} {ⅇ}^{j 2 π ( l - 1 ) ( m - 1 ) / K} .$$

The symbols p, q, k, n are used as indices for the transmit antenna, receiver antenna, subcarrier, and OFDM data symbol respectively, with 1≦p≦Nₜ, 1≦q≦Nᵣ, 1≦k≦K, 0≦n≦N. The coded bit stream is converted into Nₜ parallel data substreams by serial-to-parallel processing. One packet is composed of N OFDM data symbols where each of the data symbols is made up of K subcarriers. A guard time interval T_{g} is also included in each data symbol to eliminate inter-symbol interference (ISI). The coded symbols {dₖ^{p}(n)} drive the p-th modulator, a K-point IFFT. The coded symbols dₖ^{p}(n) are chosen from a complex-valued finite alphabet, that is,
dₖ^{p}(n)=g(b_{k,l}^{p}(n), . . . , b_{k,Q}^{p}(n)):{−1,1}^{Q}→C,
where b_{k,j}^{p}∈{−1,1} is understood to implicitly map to {1,0} if required for decoding. The n-th output of the p-th modulator is

$${s}^{p} ( t ) = {s}_{D}^{p} ( t ) {p}_{D} ( t - {T}_{d}^{g} ( n ) ) , \\ {s}_{D}^{p} ( t ) = \frac{1}{\sqrt{K}} {\sum }_{k = 0}^{K - 1} {d}_{k}^{p} ( n ) {ⅇ}^{j2π k ( t - {T}_{d}^{g} ( n ) ) / {T}_{d}} .$$

Here, T_{d}^{g} [symbol] (T_{g}+T_{d}) and p_{D}(t) is a pulse with finite support on [0,T_{d}). The channel between the p-th transmit and q-th receiver antenna, {hₗ^{p,q}(n)}, is modeled by a tapped delay line, such that the n-th received signal at the q-th antenna is

$${r}^{q} ( t ) = {\sum }_{p = 1}^{{N}_{t}} {\sum }_{l = 0}^{{N}_{f} - 1} {h}_{l}^{p , q} ( n ) {s}_{D}^{p} ( t - {lT}_{s} ) + {z}^{q} ( t ) .$$

It is assumed in the sequel that N_{ƒ}Tₛ<T_{g}, a set of channels {hₗ^{p,q}(n)} is assumed to be constant over only one OFDM packet duration, and the receiver is assumed to be matched to the transmitted pulse. The additive noise z^{q}(t) is circular white Gaussian with spectral density 2N₀. Having eliminated the guard interval, the n-th OFDM data symbol vector in the time domain is now given by

$${r}^{q} ( n ) {=}^{Δ} {\sum }_{p = 1}^{{N}_{t}} {\tilde{D}}^{p} ( n ) {h}^{p , q} ( n ) + {z}^{q} ( n ) , \\ where \\ {z}^{q} ( n ) \sim N ( {z}^{q} ( n ) ; 0 , 2 {N}_{0} / {T}_{s} {I}_{K} ) , \\ {h}^{p , q} ( n ) {=}^{Δ} {[ {h}_{0}^{p , q} ( n ) , {h}_{1}^{p , q} ( n ) , … , {h}_{{N}_{f} - 1}^{p , q} ( n ) ]}^{T} ∈ {C}^{{N}_{f}} , \\ {h}^{q} ( n ) {=}^{Δ} {[ {( {h}^{1 , q} ( n ) )}^{T} , … , {( {h}^{{N}_{t} , q} ( n ) )}^{T} ]}^{T} ∈ {C}^{{N}_{t} {N}_{f}} , \\ {\tilde{D}}^{p} ( n ) {=}^{Δ} [ \begin{matrix}{\tilde{d}}_{0}^{p} ( n ) & {\tilde{d}}_{K - 1}^{p} ( n ) & ⋯ & {\tilde{d}}_{K - {N}_{f} + 1}^{p} ( n ) \\ {\tilde{d}}_{1}^{p} ( n ) & {\tilde{d}}_{0}^{p} ( n ) & ⋯ & {\tilde{d}}_{K - {N}_{f} + 2}^{p} ( n ) \\ ⋮ & ⋮ & ⋯ & ⋯ \\ {\tilde{d}}_{K - 1}^{p} ( n ) & {\tilde{d}}_{K - 2}^{p} ( n ) & ⋯ & {\tilde{d}}_{K - {N}_{f}}^{p} ( n )\end{matrix} ] , \qquad ( 1 )$$

\tilde{D}^{p}(n) is a non-symmetric circulant matrix specified by cir(\tilde{d}^{p}(n)), and \tilde{d}^{p}(n)=Fd^{p}(n), d^{p}(n) [symbol] [d₀^{p}(n), . . . , d_{K-1}^{p}(n)]^{T}. Here, N(x;mₓ,Σₓ) denotes a circular Gaussian density with mean vector mₓ and covariance matrix Σₓ. A frequency offset at the receiver is incorporated into r^{q}(n) in Eq. (1) [following for example Exhibits J and K of the priority US provisional patent application: T. Roman, M. Enescu, and V. Koivunen, “JOINT TIME-DOMAIN TRACKING OF CHANNEL AND FREQUENCY OFFSET FOR OFDM SYSTEMS,” Proceedings of the IEEE Workshop on Signal Processing Advances in Wireless Communications, SPAWC 2003, pp. 605-609; and Z. Liu, G. B. Giannakis, and B. L. Hughes, “DOUBLE DIFFERENTIAL SPACE-TIME BLOCK CODING FOR TIME-SELECTIVE FADING CHANNELS,” IEEE Trans. on Commun., vol. 49, No. 9, pp. 1529-1539, September 2001] yielding

$${r}^{q} ( n ) {=}^{Δ} \tilde{Δ} ( {ɛ}^{q} ( n ) ) {\sum }_{p = 1}^{{N}_{t}} {\tilde{D}}^{p} ( n ) {h}^{p , q} ( n ) + {z}^{q} ( n ) . \qquad ( 2 )$$

Under the assumption that the multipaths have a common angle of arrival (AOA), the frequency offset is independent of transmit antenna and multipath indices [see Z. Liu, G. B. Giannakis, and B. L. Hughes, “DOUBLE DIFFERENTIAL SPACE-TIME BLOCK CODING FOR TIME-SELECTIVE FADING CHANNELS,” IEEE Trans. on Commun., vol. 49, pp. 1529-1539, September 2001, exhibit K of the priority US provisional patent application], but each receiver has a different frequency offset. With the frequency offset Δƒ^{q}(n), a normalized frequency offset is defined as ε^{q}(n) [symbol] Δƒ^{q}(n)N_{d}^{g}Tₛ. The K×K matrix \tilde{Δ}(ε^{q}(n)) is defined as
\tilde{Δ}(ε^{q}(n)) [symbol] e^{j2πε}^{^{q}}^{(n)((n-1)N}^{_{d}}^{^{g}}^{+N}^{_{g}}⁾×
Λ(1e^{j2πε}^{^{q}}^{(n)/N}^{_{d}}^{^{g}}, . . . , e^{j2π(K-1)ε}^{^{q}}^{(n)/N}^{_{d}}^{^{g}}) (3)

A description is now made of the Iterative Extended Soft-RLS Channel and Frequency Offset Estimator in accordance with exemplary embodiments of this invention.

The soft-RLS estimator is driven by the coded soft symbol decision d̅ₖ^{p}(n) [symbol] E[dₖ^{p}(n)], where the expectation is with respect to the APP. Conditioned on the coded soft symbol decisions, the measurement vector signal used by the q-th soft-RLS estimator is modified according to K. J. Kim and R. A. Iltis, “ITERATIVE KALMAN FILTER-BASED DATA DETECTION AND CHANNEL ESTIMATION FOR TURBO CODED MIMO-OFDM SYSTEMS”, submitted to the International Journal of Wireless Information Networks, 2005 and K. J. Kim, T. Bhatt, V. Stolpman, and R. A. Iltis, “PERFORMANCE ANALYSIS OF THE DETECTOR FOR THE STRUCTURED IRREGULAR LDPC CODED MIMO-OFDM SYSTEM”, to appear in the proceedings of ICASSP2006 (Exhibit F of the priority US provisional application), as follows:

$${r}^{q} ( n ) = \tilde{Δ} ( {ɛ}^{q} ( n ) ) {\sum }_{p = 1}^{{N}_{t}} {\overline{D}}^{p} ( n ) {h}^{p , q} ( n ) + \tilde{Δ} ( {ɛ}^{q} ( n ) ) {\sum }_{p = 1}^{{N}_{t}} {\breve{D}}^{p} ( n ) {h}^{p , q} ( n ) + {z}^{q} ( n ) . \qquad ( 4 )$$

In Eq. (4), \check{D}^{p}(n) [symbol] \tilde{D}^{p}(n)− D̅^{p}(n), and D̅^{p}(n) is \tilde{D}^{p}(n) substituting \tilde{d}ₖ^{p}(n) with E[\tilde{d}ₖ^{p}(n)]. To develop the soft-RLS estimator, first rewrite the received vector signal using a composite noise vector including the data detection errors as

$${r}^{q} ( n ) = \tilde{Δ} ( {ɛ}^{q} ( n ) ) {\sum }_{p = 1}^{{N}_{t}} {\overline{D}}^{p} ( n ) {h}^{p , q} ( n ) + {\tilde{z}}^{q} ( n ) , \qquad ( 5 )$$

where

$${\tilde{z}}^{q} ( n ) {=}^{Δ} \tilde{Δ} ( {ɛ}^{q} ( n ) ) {\sum }_{p = 1}^{{N}_{t}} {\breve{D}}^{p} ( n ) {h}^{p , q} ( n ) + {z}^{q} ( n ) .$$

Denoting by V(dₖ^{p}(n)) the variance of a coded symbol dₖ^{p}(n) and by eₖ₊₁ [symbol] [0_{1×k},1,0_{1×(K-k-1)}]^{T}, the covariance matrix \tilde{R}_{z}^{q}(n) of \tilde{z}^{q}(n) can be computed as follows:

$$\begin{matrix}{\tilde{R}}_{z}^{q} ( n ) {=}^{Δ} E [ {\tilde{z}}^{q} ( n ) {{\tilde{z}}^{q} ( n )}^{H} ] \\ = 2 {N}_{0} / {T}_{s} I + E [ {\sum }_{p = 1}^{{N}_{t}} {\breve{D}}^{p} ( n ) {h}^{p , q} ( n ) {{h}^{p , q} ( n )}^{H} {{\breve{D}}^{p} ( n )}^{H} ] , \\ = 2 {N}_{0} / {T}_{s} I + {F}_{{\breve{R}}_{z}^{q}} ( n ) {F}^{H} ,\end{matrix} \\ where \\ {\breve{R}}_{z}^{q} ( n ) {=}^{Δ} {\sum }_{p = 1}^{{N}_{t}} {\sum }_{k = 0}^{K - 1} {S}_{k + 1} ( {h}^{p , q} ( n ) ) V ( {d}_{k}^{p} ( n ) ) {e}_{k + 1} {e}_{k + 1}^{T} , \\ {S}_{k} ( {h}^{p , q} ( n ) ) {=}^{Δ} [ \begin{matrix}{0}_{1 \times k - 1} \\ ( {F}_{c}^{H} E [ {h}^{p , q} ( n ) {{h}^{p , q} ( n )}^{H} ] {F}_{c} ) ( l , \text{:} ) \\ {0}_{1 \times K - k}\end{matrix} ] . \qquad ( 6 )$$

Note that Eq. (6) holds only for known channels {h^{p,q}(n)} and is derived below in Appendix A. Note that the output APP from the soft data detector is incorporated into the ES-RLS in terms of the variance of a coded symbol.

Now to apply the RLS approach into Eq. (5), one may apply the first order linearization with respect to unknown nonlinear channel parameters in the measurement (see S. Haykin, A. H. Sayed, J. R. Zeidler, P. Yee, and P. C. Wei, “ADAPTIVE TRACKING OF LINEAR TIME-VARIANT SYSTEMS BY EXTENDED RLS ALGORITHMS”, IEEE Trans. on Signal Processing, vol. 45, pp. 1118-1128, May 1997, Exhibit H of the priority US provisional patent application). Now the linearized received vector signal becomes

$$\begin{matrix}{\tilde{r}}^{q} ( n ) = {J}^{q} ( n ) [ \begin{matrix}{ɛ}^{q} ( n ) ( 7 ) \\ {h}^{q} ( n )\end{matrix} ] + {\tilde{z}}^{q} ( n ) , \\ where & ( 8 ) \\ {\tilde{r}}^{q} ( n ) {=}^{Δ} δ {\tilde{r}}^{q} ( n ) + {J}^{q} ( n ) [ \begin{matrix}{\hat{ɛ}}^{q} ( n - 1 ) ( 9 ) \\ {\hat{h}}^{q} ( n - 1 )\end{matrix} ] . & ( 10 )\end{matrix}$$

In Eq. (10)

$$δ {\tilde{r}}^{q} ( n ) {=}^{Δ} {r}^{q} ( n ) - \tilde{Δ} ( {\hat{ɛ}}^{q} ( n - 1 ) ) {\sum }_{p = 1}^{{N}_{t}} {\overline{D}}^{p} ( n ) {\hat{h}}^{p , q} ( n - 1 ) .$$

The Jacobian matrix J^{q}(n) is defined by

$${J}^{q} ( n ) = [ {J}_{ɛ}^{q} ( n ) {J}_{h}^{q} ( n ) ] , \\ {J}_{ɛ}^{q} ( n ) {=}^{Δ} \frac{\partial {r}^{q} ( n )}{\partial {ɛ}^{q} ( n )} {\vert}_{\begin{matrix}{ɛ}^{q} ( n ) = {\hat{ɛ}}^{q} ( n - 1 ) \\ {h}^{q} ( n ) = {\hat{h}}^{q} ( n - 1 )\end{matrix}} , \\ {J}_{h}^{q} ( n ) {=}^{Δ} \frac{\partial {r}^{q} ( n )}{\partial {( {h}^{q} ( n ) )}^{T}} {\vert}_{\begin{matrix}{h}^{q} ( n ) = {\hat{h}}^{q} ( n - 1 ) \\ {ɛ}^{q} ( n ) = {\hat{ɛ}}^{q} ( n - 1 )\end{matrix}} , \qquad ( 11 )$$

each of its Jacobian sub-matrix is computed as

$${J}_{ɛ}^{q} ( n ) {=}^{Δ} Λ ( j 2 π a , … , j 2 π ( a + \frac{K - 1}{{N}_{d}^{g}} ) ) \tilde{Δ} ( {\hat{ɛ}}^{q} ( n - 1 ) ) \times [ {\overline{D}}^{1} ( n ) , … , {\overline{D}}^{{N}_{t}} ( n ) ] {\hat{h}}^{q} ( n - 1 ) , \\ {J}_{h}^{q} ( n ) {=}^{{.}^{Δ}} \tilde{Δ} ( {\hat{ɛ}}^{q} ( n - 1 ) ) [ {\overline{D}}^{1} ( n ) , … , {\overline{D}}^{{N}_{t}} ( n ) ] . \qquad ( 12 )$$

Here, α [symbol] (n−1)N_{d}^{g}+N_{g}. Considering the statistical property of \tilde{z}^{q}(n), one may change the minimizing function applying an approach used in J. McDonough, D. Raub, M. Wolfel, and A. Waibel, “TOWARDS ADAPTIVE HIDDEN MARKOV MODEL BEAMFORMERS”, 2004, submitted to the IEEE Trans. on Speech and Audio Processing (Exhibit L of the priority US provisional patent application). The ES-RLS algorithm is obtained by recursive minimization of the following

$$\{ {\hat{ɛ}}^{q} ( n ) , {\hat{h}}^{q} ( n ) \} = \text{arg} {min}_{{ɛ}^{q} ( n ) , {h}^{q} ( n )} {\sum }_{m = 1}^{n} {{β}^{n - l} ( {δ}^{q} ( m ) )}^{H} {( {\tilde{R}}_{z}^{q} ( m ) )}^{- 1} {δ}^{q} ( m ) .$$

Here,

$${δ}^{q} ( m ) {=}^{Δ} {\tilde{r}}^{q} ( m ) - {J}^{q} ( m ) [ \begin{matrix}{ɛ}^{q} ( m ) \\ {h}^{q} ( m )\end{matrix} ]$$

and β is a forgetting factor. With some computations, the following iterative ES-RLS (IES-RLS) algorithm at the l-th receiver subiteration is obtained:

$${{P}^{q , l} ( n )}^{- 1} = β {{P}^{q , l} ( n - 1 )}^{- 1} + {{J}^{q} ( n )}^{H} {( {\hat{\tilde{R}}}_{z}^{q , l} ( n ) )}^{- 1} {J}^{q} ( n ) , \\ [ \begin{matrix}{\hat{ɛ}}^{q , l} ( n ) \\ {\hat{h}}^{q , l} ( n )\end{matrix} ] = [ \begin{matrix}{\hat{ɛ}}^{q , l} ( n - 1 ) \\ {\hat{h}}^{q , l} ( n - 1 )\end{matrix} ] + {P}^{q , l} ( n ) {{J}^{p} ( n )}^{H} {( {\hat{\tilde{R}}}_{z}^{q , l} ( n ) )}^{- 1} δ {\tilde{r}}^{q , l} ( n ) ,$$

where δ_{\tilde{r}}^{q,l}(n) is δ_{\tilde{r}}^{q}(n) at the l-th receiver subiteration. The matrix P^{q}(n) corresponds to the pseudocovariance. At receiver subiteration l, the iterative RLS algorithm approximates the unknown covariance \hat{\tilde{R}}_{z}^{q,l}(n) by incorporating a previous channel estimate and APP based soft decisions, that is,

$${\hat{\tilde{R}}}_{z}^{q , l} ( n ) \approx {\sum }_{p = 1}^{{N}_{t}} {\sum }_{k = 0}^{K - 1} {S}_{k + 1} ( {\hat{h}}^{p , q , l} ( n - 1 ) ) V ( {d}_{k}^{p , l} ( n ) ) {e}_{k + 1} {e}_{k + 1}^{T} .$$

Discussed now is a Decision Directed IES-RLS Algorithm further in accordance with the exemplary embodiments of this invention.

The received vector r^{q}(n) is corrected for frequency offset and premultiplied by the FFT matrix F^{H} to yield a demodulated vector signal

$$\begin{matrix}{y}^{q} ( n ) {=}^{Δ} {F}^{H} {\tilde{Δ} ( {\hat{ɛ}}^{q} ( n - 1 ) )}^{H} {r}^{q} ( n ) \\ \approx {\sum }_{p = 1}^{{N}_{t}} {\hat{H}}^{p , q} ( n ) {d}^{p} ( n ) + {n}^{q} ( n ) .\end{matrix} \qquad ( 13 )$$

Here, one may use δε^{q}(n) [symbol] ε^{q}(n)−\hat{ε}^{q}(n−1) and assume that:
F^{H}e^{j2πδε}^{^{q}}^{((n-1)N}^{_{d}}^{^{g}}^{+N}^{_{g}}⁾Δ(δε^{q}(n))F≈I.

Also, Ĥ^{p,q}(n) is an estimated channel frequency matrix defined by

$${\hat{H}}^{p , q} ( n ) {=}^{Δ} diag \{ {\hat{H}}_{0}^{p , q} ( n ) , {\hat{H}}_{1}^{p , q} ( n ) , … , {\hat{H}}_{K - 1}^{p , q} ( n ) \} , \\ {\hat{H}}_{k}^{p , q} ( n ) {=}^{Δ} {\sum }_{l = 0}^{{N}_{f} - 1} {\hat{h}}_{l}^{p , q} ( n - 1 ) {ⅇ}^{- j2π kl / K} . \qquad ( 14 )$$

At receiver subiteration l, the soft-QRD-M algorithm (see K. J. Kim, T. Reid, and R. A. Iltis, “SOFT DATA DETECTION ALGORITHMS FOR AN ITERATIVE TURBO CODED MIMO OFDM SYSTEMS” in Proceedings of the Asilomar Conference on Signals Systems and Computers, Pacific Grove, Calif., November 2004, pp. 1193-1197, Exhibit G of the priority US provisional patent application) is run on all subcarriers based on the following approximate demodulated vector signal derived from all Nᵣ receive antennas:
yₖ(n)≈Ĥₖ^{l}(n)dₖ(n)+zₖ(n), (15)
where
dₖ(n) [symbol] [dₖ^{l}(n), . . . , dₖ^{N}^{ₗ}(n)]^{T},
nₖ(n)˜N(nₖ(n);0,2N₀/TₛI_{N}_{ₚ}_{×N}_{ₜ}). (16)

Here, Ĥₖ^{l}(n) represents the estimated frequency responses of all Nᵣ×Nₜ channels at frequency k and receiver subiteration l. The soft-QRD-M, with Nᵣ≧Nₜ, computes approximates APPs. The soft decisions at iteration l, d̅ₖ^{p,l} are obtained from the APPs using channel estimations \hat{F}ₖ^{l}(n), such that

$${\overline{d}}_{k}^{p , l} ( n ) = g ( tanh ( {L}^{l} ( {b}_{k , 1}^{p} ( n ) ) / 2 ) , … , tanh ( {L}^{l} ( {b}_{k , Q}^{p} ( n ) / 2 ) ) ) , \\ where \\ {L}^{l} ( {b}_{k , j}^{p} ( n ) ) \approx ln \frac{p ( {y}_{k} ( n ) \vert {\hat{H}}_{k}^{l} ( n ) , {b}_{k , j}^{p} = 1 )}{p ( {y}_{k} ( n ) \vert {\hat{H}}_{k}^{l} ( n ) , {b}_{k , j}^{p} = - 1 )} + {λ}_{2}^{l} ( {b}_{k , j}^{p} ) . \qquad ( 17 )$$

The prior APP λ₂^{l}(b_{k,j}^{p}) is the extrinsic from the channel decoder. The extrinsic decoder information, denoted by λ₂^{l}(b_{k,j}^{p}), becomes increasingly accurate as long as the signal to noise ratio (SNR) is above a threshold or the receiver subiteration proceeds. The channel decoder computes the APPs of the coded bits using the interleaved extrinsic bit information from the soft QRD-M, and then excludes a priori information to generate a new extrinsic as
λ₂^{Π}^{^{−1}}^{,l}(b_{k,j}^{p})=L₂^{l}(b_{k,j}^{p})−λ₁^{Π}^{^{−1}}^{,l}(b_{k,j}^{p}). (18)

In Eq. (18), λ₁^{Π}^{^{−1}}^{,1}(b_{k,j}^{p}) is a deinterleaved λ₁^{l}(b_{k,j}^{p}. On the next iteration, the soft-QRD-M uses the interleaved version of the a priori LLR, λ₂^{l}(b_{k,j}^{p}). Specifically, the new APP from the decoder λ₂^{l}(b_{k,j}^{p}) is added to the measurement LLR. Thus, the decoder extrinsic improves detector performance by providing more reliable data decisions. The extrinsic information sent to the channel decoder is determined by the LLRs by
λ₁^{l}(b_{k,j}^{p})=\hat{L}^{l}(b_{k,j}^{p}(n))−λ₂^{l}(b_{k,j}^{p}), (19)
where \hat{L^{l}}(b_{k,j}^{p}(n)) is an approximated LLRs and the a priori LLR of the coded bit b_{k,j}^{p}(n) corresponds to the interleaved extrinsic information from the previous decoding iteration.

The following parameters were used in simulations of the novel extended soft-RLS (ES-RLS) algorithm in accordance with the exemplary embodiments of this invention:
K=64, Nₜ=Nᵣ=4, N=10, the first OFDM symbol is used as training.

Fading channel powers, N_{ƒ}=5,
∥f^{p,q}(n)∥²={0.5610, 0.2520, 0.1132, 0.0509, 0.0229}, ∀p,q.
ĥ^{p,q}(0)=0∀p,q.
ε^{q}(n)˜N(ε^{q}(n);0,1e⁻⁴)∀q.
\hat{ε}^{q}(0)=0∀q.
β=0.999.
P^{q}(0)=diag{1e⁻²,100I}∀q.

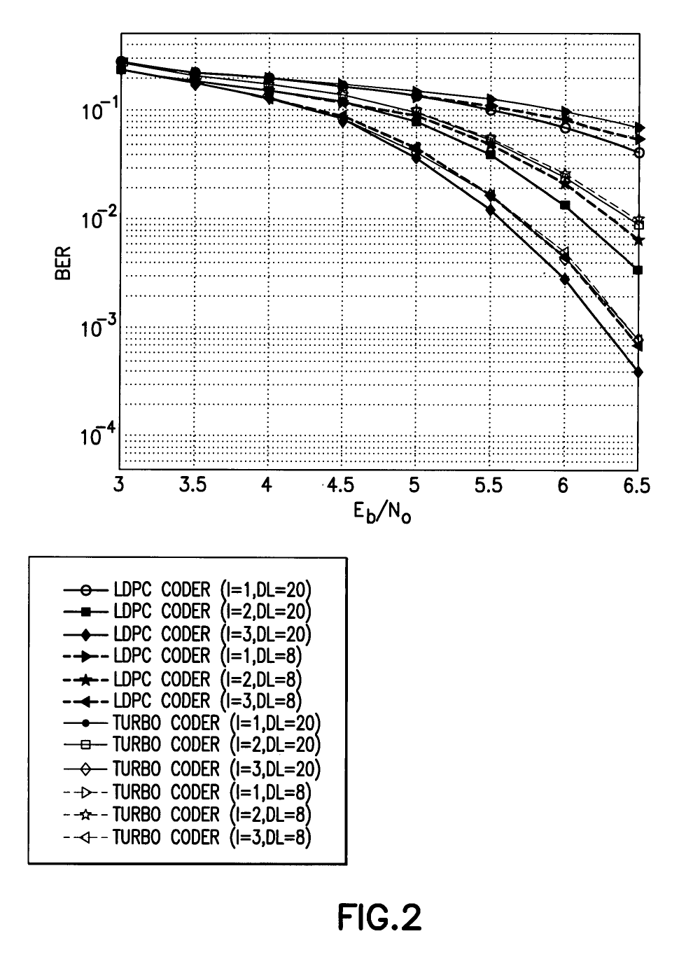

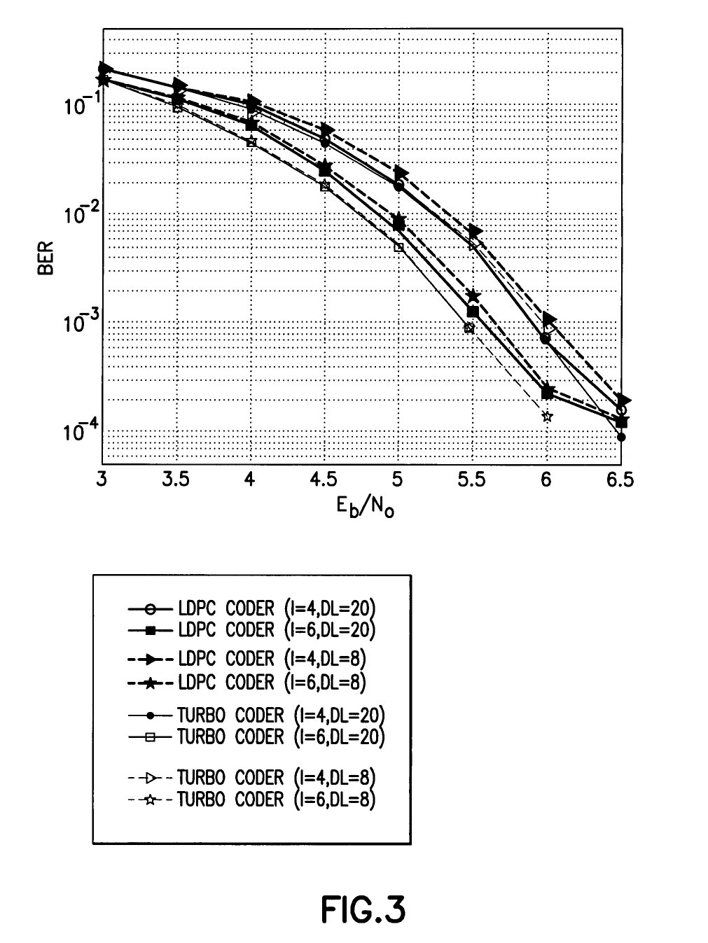

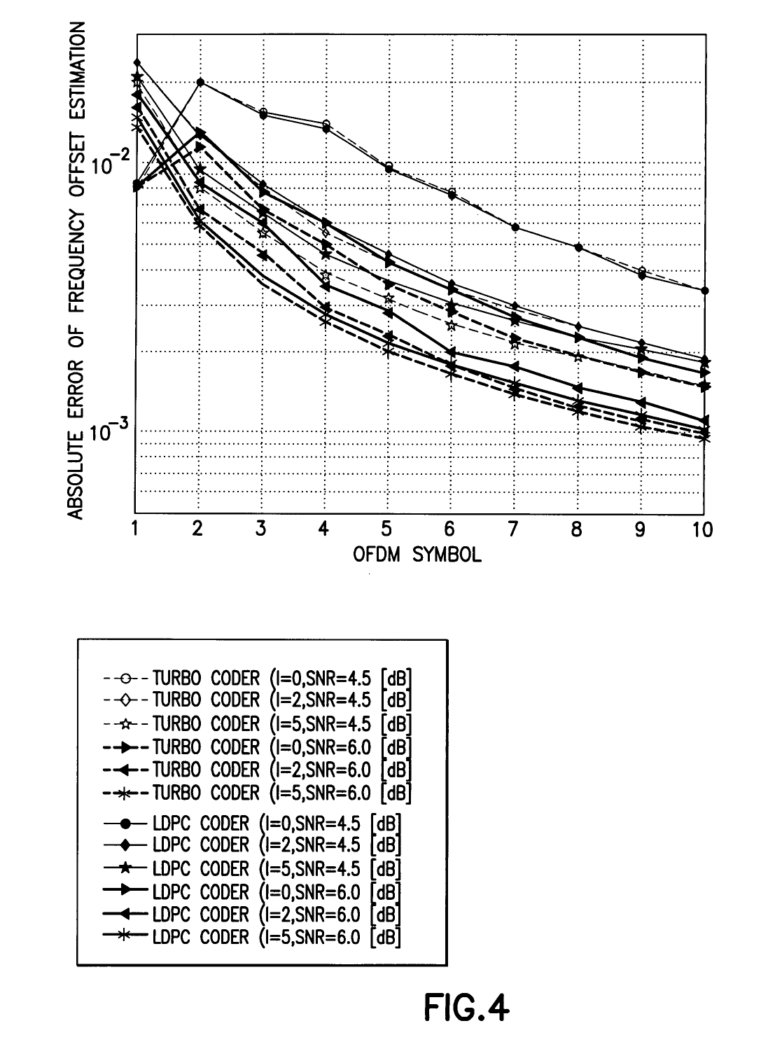

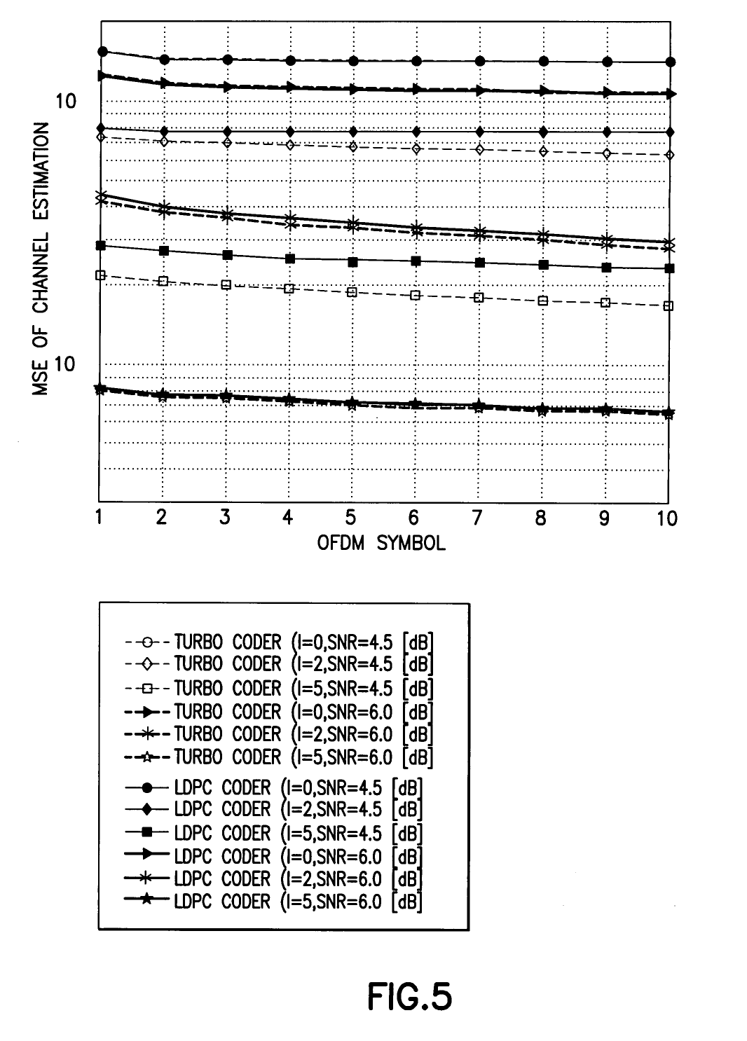

Assumed was the use of a ½-rate Turbo coder (PHYSICAL LAYER STANDARD FOR CDMA 2000 SPREAD SPECTRUM SYSTEMS (3GPP2 C.S0002-C), May 2002) of which the generation polynomial is {eeƒ}_{H} and the memory length of the constituent code is 3, and a max-log-map algorithm was used in decoding. A structured irregular LDPC coder (see V. Stolpmanl, J. Zhang, and N. W. Vaes, “IRREGULAR STRUCTURED LDPC CODES”, Proposal for IEEE 802.16 Broadband Wireless Access Working Group, 2004, Exhibit M of the priority US provisional patent application) with the same code rate was used for a comparison. A log-map or belief-propagation was used for a LDPC decoding algorithm. FIGS. 2 and 3 correspond to the bit error rate (BER) in terms of receiver iterations. Employed were (8,20) subiterations in LDPC and Turbo decoding. FIGS. 2 and 3 show that the overall performance for the LDPC coded system is more sensitive to the decoding subiteration than the Turbo coded system. Also, as the receiver iteration increases, the Turbo coded system tends to perform better than the LDPC coded system. As in FIGS. 2 and 3, the IES-RLS algorithm leads to a better joint frequency offset and channel estimations for the Turbo coded system at 20-subdecoding iterations, up to five receiver iterations, as shown in FIGS. 4 and 5. This is one example with the LDPC and Turbo codes. But we can use them in a different coding rate.

As compared to copending U.S. Provisional Patent Application No. 60/801,037, filed May 16, 2006, entitled: “METHOD, APPARATUS AND COMPUTER PROGRAM PRODUCT PROVIDING SOFT ITERATIVE RECURSIVE LEAST SQUARES (RLS) CHANNEL ESTIMATOR”, by Kyeong Jin, the use of the exemplary embodiments of this invention enables estimation of the frequency offset in addition to the channel. The frequency offset estimate is generally more difficult to estimate since it is a nonlinear state parameter.

The use of the exemplary embodiments of this invention provides a technique to combine soft information in the coded MIMO-OFDM system.

The use of the exemplary embodiments of this invention also enables one to benefit from the strong effect of channel decoders in an iterative receiver structure, and the use of the iterative method improves the overall performance.

To estimate the channel and frequency offset estimate, the exemplary embodiments of this invention use soft-information coming from the data detector.

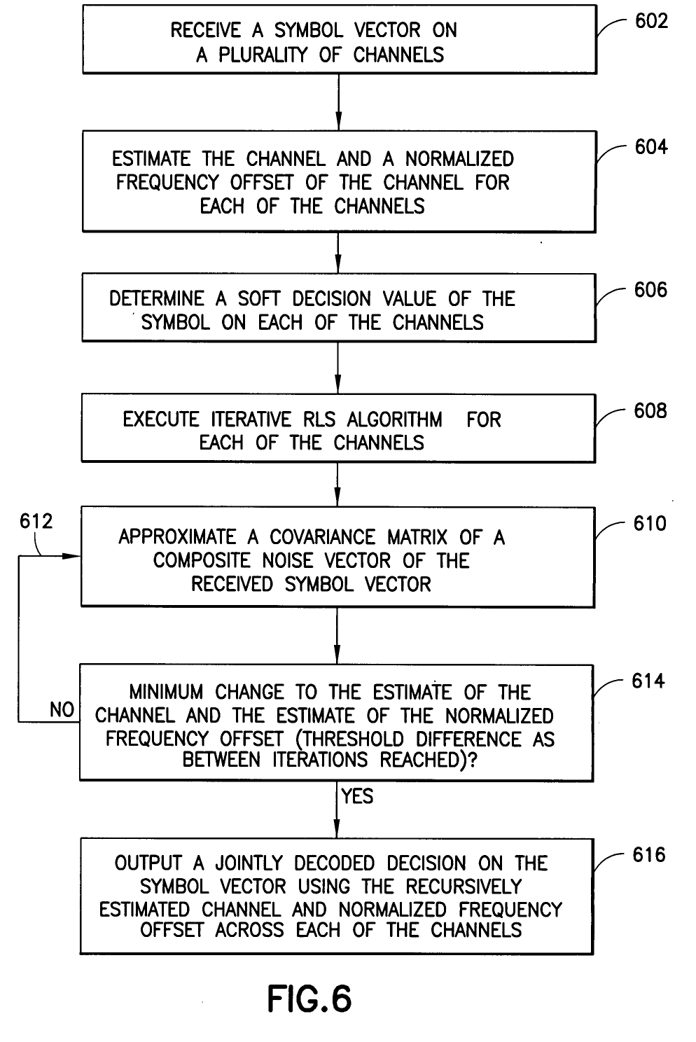

To accomplish this, and referring to the logic flow diagram of FIG. 6, a symbol vector is received on a plurality of channels at block 602. Note that in a SIMO system, there may be only one receive antenna receiving on multiple channels so embodiments of the invention may be practiced in a single-antenna receiving device. At block 604 there is estimated, for each channel, the channel and a normalized frequency offset for the channel. At block 606 a soft decision value is determined, on each of the channels, for a symbol of the received symbol vector. At block 608 generally the RLS algorithm is entered, and it is executed at block 610 where the covariance matrix of the composite noise vector of the received symbol vector is approximated, as detailed above. The RLS algorithm is iterated until the change as between iterations to the estimate of the channel and the estimate of the normalized frequency offset is reached. This minimization may be some threshold, such as a percentage change or an absolute value stored in the memory against which to compare how well the algorithm has closed on a final value. If not yet minimized, then feedback loop 612 is continued to arrive at a next approximation.

Note that the method of FIG. 6 may compute the covariance matrix of the composite noise defined in Eq. (5).

Eq. (5) may then be linearized with respect to the frequency offset to provide the Eq. (7).

As detailed above, the algorithm may compute the Jacobian matrices defined in Eq. (10) in order to approximate the covariance matrix in each iteration and to find the minimization of the changes to the channel and to the estimate of the normalized frequency offset.

Using these procedures one may estimate a linear state vector, channel vector, and a nonlinear channel parameter, the frequency offset, jointly in the coded OFDM system. From there is output the jointly decoded decision on the symbol vector at block 616, using the recursively determined normalized frequency offset for each of the channel estimates.

Based on the foregoing it should be apparent that the exemplary embodiments of this invention provide a method, apparatus and computer program product(s) to perform an iterative extended soft-RLS (IES-RLS) algorithm for joint channel and frequency offset estimation for a coded MIMO-OFDM system, wherein the a posteriori probability for an information bit computed from the channel decoder is used in the MIMO data detector, whose coded soft symbol decision is used in the IES-RLS algorithm. In an exemplary and non-limiting embodiment first order linearization with respect to channel parameters is employed. The FES-RLS algorithm may be employed with, as two non-limiting examples, Turbo and regular/irregular LDPC codes.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The exemplary embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

Appendix A: Computationof Composite Noise Covariance

Recall that

$${\breve{R}}_{z}^{q} ( n ) {=}^{Δ} E [ {\sum }_{p = 1}^{{N}_{t}} {\breve{D}}^{p} ( n ) {h}^{p , q} ( n ) {{h}^{p , q} ( n )}^{H} {{\breve{D}}^{p} ( n )}^{H} ] . \qquad ( A .1 )$$

To compute Eq. (A.1), use the following properties for the circulant matrix \check{D}^{p}(n):
\check{D}^{p}(n)=FΛ(F^{H}\check{d}^{p}(n))F_{C}^{H}, (A.2)
where \check{d}^{p}(n) is the first column vector of \check{D}^{p}(n) and F_{C} is the truncated IFFT matrix of F, whose dimension is K×N_{ƒ}. Since \check{d}^{p}(n)=F(d^{p}(n)− d̅^{p}(n)), one obtains
\check{D}^{p}(n)=FΛ((d^{p}(n)− d̅^{p}(n)))F_{C}^{H}. (A.3)

Substituting Eq. (A.3) into Eq. (A.1), one has

$${{R}^{}}_{z}^{q} ( n ) = FA ( n ) {F}^{H} , \\ where \\ A ( n ) {=}^{Δ} E {\sum }_{p = 1}^{{N}_{t}} Λ ( δ {d}^{p} ( n ) ) {F}_{C}^{H} {h}^{p , q} ( n ) {( {h}^{p , q} ( n ) )}^{H} {F}_{C} Λ {( δ {d}^{p} ( n ) )}^{H} \qquad ( A .4 )$$

and δd^{p}(n)=d^{p}(n)− d̅^{p}(n). Following the approach proven in K. J. Kim, T. Reid, and R. A. Iltis, “DATA DETECTION AND SOFT-KALMAN FILTER BASED SEMI-BLIND CHANNEL ESTIMATION FOR MIMO-OFDM SYSTEMS”, in Proceedings of ICC2005, 2005, pp. 2488-2492 (Exhibit D of the priority US provisional patent application), one can show that

$$E [ Λ ( δ {d}^{p} ( n ) ) {F}_{C}^{H} {h}^{p , q} ( n ) {( {h}^{p , q} ( n ) )}^{H} {F}_{C} {Λ ( δ {d}^{p} ( n ) )}^{H} ] = \\ {\sum }_{k = 0}^{K - 1} {S}_{k + 1} ( {h}^{p , q} ( n ) ) [ E \{ {\vert {d}_{k}^{p} ( n ) \vert}^{2} \} - {\vert {\overline{d}}_{k}^{p} ( n ) \vert}^{2} ] {e}_{k + 1} {e}_{k + 1}^{T} , \\ where {S}_{l} ( {h}^{p , q} ( n ) ) {=}^{Δ} [ \begin{matrix}{0}_{1 \times l - 1} ( A .5 ) \\ ( {F}_{c}^{H} E [ {h}^{p , q} ( n ) {{h}^{p , q} ( n )}^{H} ] {F}_{c} ) ( l , : ) ( A .6 ) \\ {0}_{1 \times K - l} ( A .7 )\end{matrix} ] , \\ {e}_{k + 1} {=}^{Δ} {[ {0}_{1 \times k} , 1 , {0}_{1 \times ( K - k - 1 )} ]}^{T} . \\ \qquad ( A .8 )$$

In the computation of Eq. (A.8) uncorrelated symbol errors across the carriers are assumed. Now defining V(dₖ^{p}(n)) [symbol] E{|dₖ^{p}(n)|^{2}-| d̅}ₖ^{p}(n)|² and substituting eq. (A.8) into Eq. (A.4) yields Eq. (6) above, which completes the derivation.

What is claimed is:

1. A method comprising:
receiving a symbol vector on a plurality of channels;
for each of the channels, estimating the channel and a normalized frequency offset of the channel;
for each of the channels, determining a soft decision value of the symbol vector;
executing an iterative recursive least squares RLS algorithm on each of the channels that approximates a covariance matrix of a composite noise vector of the received symbol vector until a minimum change to the estimate of the channel and the estimate of the normalized frequency offset is reached; and
using the recursively estimated channel and normalized frequency offset across each of the channels, outputting a jointly decoded decision on the symbol vector.

2. The method of claim 1, wherein the soft decision value is determined using an a posteriori probability APP, and the iterative RLS algorithm approximates the covariance matrix by incorporating the APP based soft decision.

3. The method of claim 2, wherein the iterative RLS algorithm incorporates the APP based soft decision using a variance of a symbol of the received symbol vector.

4. The method of claim 2, wherein the iterative RLS algorithm approximates the covariance matrix by further incorporating a previous channel estimate.

5. The method of claim 1, wherein the iterative RLS algorithm is executed on each of the channels received at each or at least two receive antennas.

6. The method of claim 1, wherein outputting the jointly decoded decision on the symbol vector comprises:
correcting each of the channels for the normalized frequency offset that was finally determined for that channel;
multiplying the received symbol vector corrected for the finally determined normalized frequency offset; and
multiplying by a fast Fourier transform matrix to output a demodulated signal vector.

7. The method of claim 1, wherein executing the iterative RLS algorithm comprises linearizing the received symbol vector on each channel using a Jacobean matrix.

8. A program of machine-readable instructions, tangibly embodied on a computer readable memory and executable by a digital data processor, to perform actions directed toward outputting a decision on a received symbol vector, the actions comprising:
receiving a symbol vector on a plurality of channels;
for each of the channels, estimating the channel and a normalized frequency offset of the channel;
for each of the channels, determining a soft decision value of the symbol vector;
executing an iterative recursive least squares RLS algorithm on each of the channels that approximates a covariance matrix of a composite noise vector of the received symbol vector until a minimum change to the estimate of the channel and the estimate of the normalized frequency offset is reached; and
using the recursively estimated channel and normalized frequency offset across each of the channels, outputting a jointly decoded decision on the symbol vector.

9. The program of claim 8, wherein the soft decision value is determined using an a posteriori probability APP, and the iterative RLS algorithm approximates the covariance matrix by incorporating the APP based soft decision.

10. The program of claim 9, wherein the iterative RLS algorithm incorporates the APP based soft decision using a variance of a symbol of the received symbol vector.

11. The program of claim 9, wherein the iterative RLS algorithm approximates the covariance matrix by further incorporating a previous channel estimate.

12. The program of claim 8, wherein the iterative RLS algorithm is executed on each of the channels received at each of at least two receive antennas.

13. The program of claim 8, wherein outputting the jointly decoded decision on the symbol vector comprises:
correcting each of the channels for the normalized frequency offset that was finally determined for that channel;
multiplying the received symbol vector corrected for the finally determined normalized frequency offset; and
multiplying by a fast Fourier transform matrix to output a demodulated signal vector.

14. The program of claim 8, wherein executing the iterative RLS algorithm comprises linearizing the received symbol vector on each channel using a Jacobean matrix.

15. A device comprising:
at least one receive antenna coupled to a receiver and adapted to receive a symbol vector on a plurality of channels;
a processor coupled to a memory adapted, for each of the channels:
to estimate the channel and a normalized frequency offset of the channel,
to determine a soft decision value of the symbol vector,
to execute an iterative recursive least squares RLS algorithm on each of the channels that approximates a covariance matrix of a composite noise vector of the received symbol vector until a minimum change to the estimate of the channel and the estimate of the normalized frequency offset is reached; and thereafter
to apply the recursively estimated channel and the normalized frequency offset across each of the channels in order to determine a jointly decoded decision on the symbol vector.

16. The device of claim 15, wherein the processor determines the soft decision value using an a posteriori probability APP, and incorporates the APP based soft decision to approximate the covariance matrix.

17. The device of claim 16, wherein the processor uses a variance of a symbol of the received symbol vector to incorporate the APP based soft decision.

18. The device of claim 16, wherein the processor approximates the covariance matrix by further incorporating a previous channel estimate.

19. The device of claim 15, wherein the at least one receive antenna comprises at least two receive antennas, and the processor executes the iterative RLS algorithm on each of the channels received at each of at the at least two receive antennas.

20. The device of claim 15, wherein the processor outputs the jointly decoded decision on the symbol vector by:
correcting each of the channels for the normalized frequency offset that was finally determined for that channel;
multiplying the received symbol vector corrected for the finally determined normalized frequency offset; and
multiplying by a fast Fourier transform matrix to output a demodulated signal vector.

21. The device of claim 15, wherein the processor is adapted to linearize the received symbol vector on each channel using a Jacobean matrix in the iterative RLS algorithm.

22. The device of claim 15 comprising a mobile station.

23. A device comprising:
means for receiving a symbol vector on a plurality of channels;
for each of the channels, means for estimating the channel and a normalized frequency offset of the channel;
for each of the channels, means for determining a soft decision value of the symbol vector;
means for executing an iterative recursive least squares RLS algorithm on each of the channels that approximates a covariance matrix of a composite noise vector of the received symbol vector until a minimum change to the estimate of the channel and the estimate of the normalized frequency offset is reached; and
means for outputting a jointly decoded decision on the symbol vector using the recursively estimated channel and normalized frequency offset across each of the channels.

24. The device of claim 23, wherein:
the means for receiving comprises at least one receive antenna coupled to a receiver;
the means for determining comprises, for each channel, a detector of a processor; and
the means for estimating and means for executing comprises a processor coupled to a memory for storing a program, and the means for outputting comprises a terminal pin of the processor.
